(19) United States
(12) Patent Application Publication
(10) Pub. No.: US 2014/0308498 A1
(43) Pub. Date: Oct. 16, 2014

(54) WINDOW FOR DISPLAY DEVICE AND DISPLAY DEVICE INCLUDING THE WINDOW

(71) Applicant: Samsung Display Co., Ltd., Yongin-City (KR)

(72) Inventors: Ju-Suk OH, Yongin-City (KR); Yuki HONGO, Yongin-City (KR); Hun-Kyo KIM, Yongin-City (KR); Hyoung-Suk ROH, Yongin-City (KR)

(21) Appl. No.: 14/010,216

(22) Filed: Aug. 26, 2013

(30) Foreign Application Priority Data
Apr. 16, 2013 (KR) 10-2013-0041732

(51) Int. Cl. B32B 27/08; B29C 45/16

(52) U.S. Cl. CPC B32B 27/08; B29C 45/16
USPC 428/220; 428/412; 428/522; 428/500; 428/423.1; 428/480; 264/259

(57) ABSTRACT

A window for a display device includes a plastic substrate, a light transmittance resin layer positioned on one side of the plastic substrate and including a light transmittance resin having a thermal distortion temperature greater than or equal to about 90° C., and a binder layer positioned between the plastic substrate and the light transmittance resin layer and including a thermosetting resin and an isocyanate compound. A display device includes the window as described above.

### CLAIM OF PRIORITY

This application makes reference to, incorporates into this specification the entire contents of, and claims all benefits accruing under 35 U.S.C. §119 from an application earlier filed in the Korean Intellectual Property Office on Apr. 16, 2013 and there duly assigned Serial No. 10-2013-0041732.

### BACKGROUND OF THE INVENTION

1. Field of the Invention

The present invention relates to a window for a display device and a display device including the same.

2. Description of the Related Art

Currently known display devices include a liquid crystal display (LCD), a plasma display panel (PDP), an organic light emitting diode display (OLED), a field effect display (FED), an electrophoretic display device, and the like. Such a display device includes a display module displaying an image and a window protecting the display module. Glass may be used as the window. However, since glass may be easily broken by external impact, when used in a portable device such as a mobile phone, it may be easily damaged. Therefore, recently, a window made of plastic material instead of glass has been researched. On the other hand, the window made of plastic may include a plurality of polymer layers. The polymer layers have different thermal characteristics which weakens adherence between the polymer layers or deforms appearance of the window, for example, curls or waives the window.

### SUMMARY OF THE INVENTION

One embodiment of the invention provides a window for a display device capable of improving adherence among a plurality of polymer layers and preventing appearance deformation.

Another embodiment provides a display device including the window.

According to one embodiment, a window for a display device includes a plastic substrate, a light transmittance resin layer positioned on one side of the plastic substrate and including a light transmittance resin having a thermal distortion temperature greater than or equal to about 90° C., and a binder layer positioned between the plastic substrate and the light transmittance resin layer and including a thermosetting resin and an isocyanate compound.

The light transmittance resin may include polycarbonate (PC), polymethylmethacrylate (PMMA), a polycarbonate-polymethylmethacrylate (PC-PMMA) copolymer, a cycloolefin polymer (COP), a copolymer thereof, or a combination thereof.

The light transmittance resin may have a thermal distortion temperature of about 90° C. to about 150° C.

The light transmittance resin may have a molecular weight of about 20000 to about 50000.

The thermosetting resin may include a urethane-based resin, a polyester-based resin, or a combination thereof.

The isocyanate compound may be included in an amount of about 1% to about 10% based on the total amount of the binder layer.

The plastic substrate may include a polyethyleneterephthalate (PET) film, a polycarbonatea (PC) film, a polymethylmethacrylate (PMMA) film, a polycarbonate/polymethylmethacrylate (PC/PMMA) film, or a combination thereof.

The window for a display device may further include an auxiliary layer positioned between the plastic substrate and the light transmittance resin layer and including a thermoplastic resin.

The thermoplastic resin may further include a polycarbonate, an acryl-based resin, a polyester-based resin, or a combination thereof.

The window for a display device may have a sequential stacking structure in an order of the plastic substrate, the binder layer, the auxiliary layer, and the light transmittance resin layer.

The window for a display device may further include a hard coating layer positioned on the other side of the plastic substrate.

The hard coating layer may include an organic material, an inorganic material, or an organic/inorganic composite compound.

The window for a display device may have a thickness less than or equal to about 1 mm.

The window for a display device may have a thickness of about 0.4 mm to about 1.0 mm.

The window for a display device may be obtained by injection molding the plastic substrate, the light transmittance resin layer, and the binder layer in a film insert manner.

According to another embodiment, a display device including the window for a display device is provided.

Adherence among a plurality of polymer layers may be improved and appearance deformation may be prevented.

### BRIEF DESCRIPTION OF THE DRAWING

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein:

FIG. 1 is a cross-sectional view showing a window for a display device according to one embodiment of the invention.

### DETAILED DESCRIPTION OF THE INVENTION

This invention will be described more fully hereinafter with reference to the accompanying drawings, in which exemplary embodiments are shown. As those skilled in the art will realize, the described embodiments may be modified in various different ways, all without departing from the spirit or scope of the present invention.

In the drawings, the thickness of layers, films, panels, regions, etc. are exaggerated for clarity. Like reference numerals designate like elements throughout the specification. It will be understood that, when an element such as a layer, film, region, or substrate is referred to as being “on” another element, it may be directly on the other element or intervening elements may also be present. In contrast, when an element is referred to as being “directly on” another element, there are no intervening elements present.

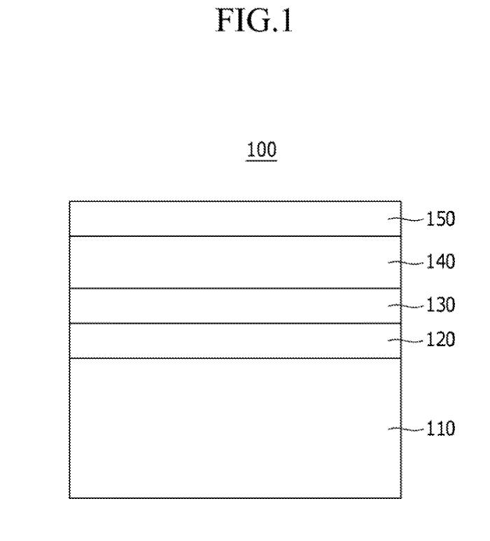

Referring to FIG. 1, a window for a display device according to one embodiment will be described.

FIG. 1 is a cross-sectional view showing a window for a display device according to one embodiment of the invention.

A window 100 for a display device according to one embodiment includes a plastic substrate 110, a light transmittance resin layer 140, and a binder layer 120 positioned between the plastic substrate 110 and light transmittance resin layer 140.

The plastic substrate 110 is a substrate used for a film insert forming process, for example, a polyethyleneterephthalate (PET) film, a polycarbonate (PC) film, a polymethylmethacrylate (PMMA) film, a polycarbonate/polymethylmethacrylate (PC/PMMA) film, or a combination thereof. The plastic substrate 140 may have, for example a thickness of about 30 μm to about 200 μm.

The light transmittance resin layer 140 may be formed of a light transmittance resin, and the light transmittance resin may be a polymer resin having a thermal distortion temperature greater than or equal to about 90° C. among polymer resins available for injection molding. The thermal distortion temperature is a temperature where a specimen starts to have deformation of 0.254 mm when the specimen is fixed on a holder, dipped in silicone oil by applying a reference load thereto, and heated at a predetermined speed. The reference load may be 264 psi (18.6 kgf/cm²) or 66 psi (6.4 kgf/cm²). The light transmittance resin has a higher thermal distortion temperature of about 90° C., and thus may prevent shape distortion and delamination promotion due to resin deformation in a high temperature/humidity environment test.

The light transmittance resin may have a thermal distortion temperature of about 90° C. to about 150° C.

The light transmittance resin may have a molecular weight of about 20000 to about 50000.

Such a light transmittance resin may include, for example, polycarbonate (PC), polymethylmethacrylate (PMMA), a polycarbonate-polymethylmethacrylate (PC-PMMA) copolymer, a cycloolefin polymer (COP), a copolymer thereof, or a combination thereof, but it is not limited thereto. Herein, the ‘combination’ may refer to a blend or a stack of two or more layers.

The light transmittance resin layer 140 may have a thickness of about 300 um to about 700 μm.

The binder layer 120 may be positioned between the plastic substrate 110 and light transmittance resin layer 140, and may include a thermosetting resin and an isocyanate compound.

The isocyanate compound may play the role of a curing agent and increase cross-linking between the plastic substrate 110 and the binder layer 120, and between the light transmittance resin layer 140 and the binder layer 120, and thus adherence therebetween.

The thermosetting resin and the isocyanate compound may be prepared to form a two-component curable resin. Herein, the two-component curable resin indicates that the thermosetting resin and the isocyanate compound are separate.

The thermosetting resin and the isocyanate compound may be mixed or dispersed in a solvent and prepared to form a composition.

The thermosetting resin may include, for example, a urethane-based resin, a polyester-based resin, or a combination thereof.

The isocyanate compound may include, for example, monoisocyanate, diisocyanate, a polyvalent isocyanate compound of triisocyanate or more, and specifically, a diisocyanate compound. The diisocyanate compound may include conventional various diisocyanate compounds such as alicyclic, aromatic, and aliphatic diisocyanate compounds. The isocyanate compound may be used singularly or as a mixture of more than two, as needed.

The alicyclic diisocyanate compound may be, for example, cyclohexane-1,4-diisocyanate, isophorone diisocyanate, dicyclohexylmethane-4,4′-diisocyanate, 1,3-bis(isocyanatemethyl)cyclohexane, methylcyclohexane diisocyanate, norbornane diisocyanate, and the like.

The aromatic diisocyanate compound may be 1,5-naphthylene diisocyanate, 4,4′-diphenylmethane diisocyanate, 4,4′-diphenyldimethylmethane diisocyanate, 4,4′-dibenzyl isocyanate, dialkyldiphenylmethane diisocyanate, tetraalkyldiphenylmethane diisocyanate, 1,3-phenylene diisocyanate, 1,4-phenylene diisocyanate, tolylene diisocyanate, xylylene diisocyanate, and the like.

The aliphatic diisocyanate compound may be butane-1,4-diisocyanate, hexamethylene diisocyanate, isopropylene diisocyanate, methylene diisocyanate, 2,2,4-trimethylhexamethylene diisocyanate, m-tetramethylxylylene diisocyanate, lysine diisocyanate, dimer diisocyanate having isocyanate groups converted from carboxyl groups of dimeric acid, and the like.

The solvent may be, for example, an ester-based solvent, a ketone-based solvent, a glycol ether-based solvent, an aliphatic solvent, an aromatic solvent, an alcohol-based solvent, an ether-based solvent, and the like. These solvents may be used in a mixture of two or more, as needed.

The ester-based solvent may be, for example, ethyl formate, propyl formate, butyl formate, isobutyl formate, pentyl formate, methyl acetate, ethyl acetate, n-propyl acetate, isopropyl acetate, n-butyl acetate, isobutyl acetate, sec-butyl acetate, (iso)amyl acetate, cyclohexyl acetate, ethyl lactate, 3-methoxybutyl acetate, sec-hexyl acetate, 2-ethylbutyl acetate, 2-ethylhexyl acetate, benzyl acetate, methyl propionate, ethyl propionate, butyl propionate, isoamyl propionate, γ-butyrolactone, and the like, and ketone-based solvent may include, for example, acetone, methylethylketone, methylpropylketone, diethylketone, methyln-butylketone, methylisobutylketone, dipropylketone, diisobutylketone, methylamylketone, acetonylacetone, isophorone, cyclohexanone, methylcyclohexanone, and the like.

The glycol ether-based solvent may be, for example, ethyleneglycol monoethylether, ethyleneglycol monoisopropylether, ethyleneglycol monobutylether, diethyleneglycol monoethylether, diethyleneglycol mono n-butylether, propyleneglycol monomethylether, propyleneglycol monoethylether, propyleneglycol mono n-propylether, propyleneglycol mono n-butylether, dipropyleneglycol monomethylether, dipropyleneglycol monoethylether, dipropyleneglycol mono n-propylether, dipropyleneglycol mono n-butylether, triethyleneglycol monomethylether, triethyleneglycol monoethylether, triethyleneglycol mono n-propylether, triethyleneglycol mono n-butylether, tripropyleneglycol monoethylether, tripropyleneglycol mono n-propylether, tripropyleneglycol mono n-butylether and acetate esters of these monoethers, dialkylethers such as diethyleneglycol dimethylether, diethyleneglycol diethylether, dipropyleneglycol dimethylether, dipropyleneglycol diethylether, and the like.

The aliphatic solvent may be a normal paraffin-based solvent, an isoparaffin-based solvent, a cycloparaffin-based solvent, and the like, and specifically, examples of the normal paraffin-based solvent may include n-hexane, n-heptane, n-octane, n-nonane, n-decane, n-dodecane, No. 0 solvent L, M, H (Nippon Oil Co., Ltd), normal paraffin SL, L, M (Nippon Oil Co., Ltd), and the like, examples of the isoparaffin-based solvent may include isohexane, 2,2,3-trimethylpentane, isooctane, 2,2,5-trimethylhexane, isosol 200, 300, 400 (Nippon Oil Co., Ltd), Super-sol FP2, 25, 30, 38 (Idemitsu Kosan Co., Ltd.), and the like, and examples of the cycloparaffin-based solvent may include cyclopentane, methylcyclopentane, cyclohexane, methylcyclohexane, ethylcyclohexane, naphtesol 160, 200, 220 (Nippon Oil Co., Ltd.), AF solvent No. 4, 5, 6, and 7 (Nippon Oil Co., Ltd.), and the like.

The aromatic solvent may include, for example, toluene, xylene, ethylbenzene, naphthalene, tetralin, solvent naphtha, and the like.

The alcohol-based solvent may be, for example, methanol, ethanol, n-propylalcohol, isopropylalcohol, n-butanol, isobutanol, sec-butanol, t-butanol, n-amylalcohol, sec-amylalcohol, 1-ethyl-1-propanol, 2-methyl-1-butanol, isoamylalcohol, t-amylalcohol, sec-isoamylalcohol, neoamylalcohol, hexylalcohol, 2-methyl-1-pentenol, 4-methyl-2-pentenol, heptanol, octanol, 2-ethylhexylalcohol, nonylalcohol, decylalcohol, undecylalcohol, laurylalcohol, benzylalcohol, α-terpineol, cyclohexanol, 3-methoxybutanol, diacetonealcohol, and the like.

The ether-based solvent may be, for example, cyclic ether such as tetrahydrofuran, 1,3-dioxolane, and the like. Other liquid solvents may include dimethylcarbonate, ethylmethylcarbonate, di-n-butylcarbonate, and the like.

The solvent may be used singularly or in a combination of two or more.

The isocyanate compound may be used in an amount of about 1% to about 10% based on the total amount of the binder layer 120. When the isocyanate compound is used within the above range, the binder layer 120 may have a thickness of about 5 μm to about 15 μm.

The window 100 for a display device further includes an auxiliary layer 130 positioned between the plastic substrate 110 and the light transmittance resin layer 140. The auxiliary layer 130 may improve adherence between the plastic substrate 110 and the light transmittance resin layer 140.

The auxiliary layer 130 may include a thermoplastic resin, and a thermoplastic resin may include, for example a polycarbonate resin, an acryl-based resin, a polyester-based resin, or a combination thereof.

The auxiliary layer 130 may have a thickness of, for example, about 5 μm to about 15 μm.

The auxiliary layer 130 may be omitted as needed.

The window 100 for a display device includes a hard coating layer 150 on the other side of the light transmittance resin layer 140 relative to the plastic substrate 110.

The hard coating layer 150 is positioned on utmost top of the window 100 for a display device, and may further improve surface hardness thereof. Herein, the hard coating layer 150 on the utmost top of the window has a direct influence on surface hardness of the window 100 for a display device, but an additional layer for applying an additional function thereto, such as an antireflective film, may be formed thereon.

The hard coating layer 150 may include, for example an organic material, an inorganic material, or an organic/inorganic composite compound. Herein the organic material may include, for example, an acryl-based compound, an epoxy-based compound, or a combination thereof, the inorganic material may include, for example, silica, alumina, or a combination thereof, and the organic/inorganic composite compound may include, for example, polysilsesquioxane. The hard coating layer 150 may be a monolayer or a plural layer, and for example may have a thickness of about 5 μm to about 15 μm.

The window 100 for a display device may have a sequential stacking structure in an order of the plastic substrate 110, binder layer 120, auxiliary layer 130, and light transmittance resin layer 140, and may be obtained by injection molding the plastic substrate 110 and the foregoing layers in a film insert manner.

The window 100 for a display device may have a thickness of less than or equal to about 1 mm, and specifically about 0.4 mm to about 1.0 mm. When the window 100 for a display device has a thickness within that range, a sufficient space for inflow of a light transmittance resin in a film insert manner during the injection molding may be secured, and thus may obtain impact resistance and surface hardness characteristics of the aforementioned light transmittance resin and satisfactory appearance of the window.

The above described window 100 for a display device may be used in various display devices. The display device may be a liquid crystal display (LCD), an organic light emitting diode (OLED) display, a plasma display, an electric field effect display device, an electrophoresis display device, and the like, but is not limited thereto.

The window 100 for a display device may be disposed on a display module, wherein the display module may be a liquid crystal display module, an organic light emitting display module, a plasma display module, an electric field effect display module, an electrophoresis display module, and the like.

Hereinafter, the present disclosure is illustrated in more detail with reference to examples. However, these examples are exemplary, and the present disclosure is not limited thereto.

### Manufacture of Window for Display Device

### Example 1

A hard coating solution (OPSTER KZ6445A, JSR Co.) was coated on one side of a PET film (PET100A4300, TOYOBO Co., Ltd.) as a plastic substrate, dried at 80° C. for 1 minute, and cured by radiating an ultraviolet (UV) ray (300 mJ/cm²). Subsequently, a two-component curable resin mixed solution (using HIPET9300 made by JUJO Chemical Co., Ltd. as a main component, 5% of JA-980 Isocyanate made by JUJO Chemical Co., Ltd. as a curing agent) was coated on the other side of the PET film, and a solvent prepared by mixing cyclohexanone and methylethylketone (MEK) in a ratio of 1:1 and diluting the mixture into 20% was screen-printed on the other side of the PET film and dried at 90° C. for 120 minutes, forming a binder layer. Then, a thermoplastic resin solution (G-2S, JUJO Chemical Co., Ltd) was coated on the binder layer and dried at 90° C. for 120 minutes. Subsequently, an auxiliary layer was formed in the same method as aforementioned. Then, the PET film was put in an injection molder to injection-mold a polycarbonate (PC) resin (lupilon S-3000, Mitsubishi Engineering Plastics Co.) having an average molecular weight of 25,000 and a thermal distortion temperature of 124° C. measured under a reference load of 264 psi (18.6 kgf/cm²), manufacturing a 0.7 mm-thick window for a display device including a light transmittance resin layer.

Thickness of a hard coating layer: 10 μm; thickness of a PET film: 100 μm; thickness of a binder layer: 10 μm; thickness of an auxiliary layer: 10 μm; and thickness of a light transmittance resin layer: 570 μm.

### Example 2

A 0.5 mm-thick window for a display device was manufactured according to the same method as Example 1 except a 50 μm-thick PET film was used instead of the 100 μm-thick PET film, and a 420 μm light transmittance resin (PC) layer was used instead of the 570 μm-thick light transmittance resin (PC) layer.

### Example 3

A 0.7 mm-thick window for a display device was manufactured according to the same method as Example 1 except for using “3200 series (JUJO Chemical Co., Ltd.)” instead of “HIPET9300 (JUJO Chemical Co., Ltd.)” as a main component for the two-component curable resin mixed solution, “A-5 (JUJO Chemical Co., Ltd.)” instead of “G-2S (JUJO Chemical Co., Ltd.)” as a thermoplastic resin, and “polymethylmethacrylate (PMMA) having a thermal distortion temperature of 99° C. measured under a reference load of 264 psi (18.6 kgf/cm²) (SUMIPEX EX, Sumitomo Chemical Co., Ltd.) instead of the polycarbonate (PC) having a weight average molecular weight of 30000 and a thermal distortion temperature of 124° C. measured under a reference load of 264 psi (18.6 kgf/cm²)” as a light transmittance resin.

### Comparative Example 1

A 0.7 mm-thick window for a display device was fabricated according to the same method as Example 1 except for including no two-component curable binder layer.

### Comparative Example 2

A 0.7 mm-thick window for a display device was manufactured according to the same method as Example 1 except for using “polymethylmethacrylate (PMMA) having a thermal distortion temperature of 82° C. measured under a reference load of 264 psi (18.6 kgf/cm²) (SUMIPEX LG35, Sumitomo Chemical Do., Ltd.)” instead of the polymethylmethacrylate (PMMA) having a thermal distortion temperature of 99° C. measured under a reference load of 264 psi (18.6 kgf/cm²) (SUMIPEX EX, Sumitomo Chemical Co., Ltd.” to form a light transmittance resin layer.

### Evaluation

Close contacting properties, appearance, and haze of the windows for a display device according to Examples 1 to 3 and Comparative Examples 1 to 2 were evaluated.

The close contacting properties were evaluated by examining to determine whether the windows for a display device had delamination between layers with naked eyes after allowed to stand at 85° C. for 240 hours under humidity of 85%.

The appearance was evaluated by examining to determine whether the windows for a display device were curled or waived with naked eyes.

The haze was measured by using a haze meter, HM-150 (MURAKAMI Color Research Lab. Co., Ltd.).

The results are provided in Table 1.

TABLE 1

| | | Two- | Light | Results | | |
|---|---|---|---|---|---|---|
| | | component | transmittance resin | Close contacting | | |
| | Thickness | curable resin | Thermal distortion | properties | | Haze |
| | (mm) | Curing agent | temperature (° C.) | (85° C., 85%, 240 h) | Appearance | (%) |
| Example 1 | 0.7 | isocyanate | 124 | OK | OK | 0.5 |
| Example 2 | 0.5 | isocyanate | 124 | OK | OK | 0.5 |
| Example 3 | 0.7 | isocyanate | 99 | OK | OK | 0.5 |
| Comparative | 0.7 | None | 124 | NG | OK | 0.6 |
| Example 1 | | | | | | |
| Comparative | 0.7 | isocyanate | 82 | OK | NG | 0.6 |
| Example 2 | | | | | | |

Referring to Table 1, the windows for a display device according to Examples 1 to 3 showed high close contacting properties and transparency and satisfactory appearance. Conversely, the window for a display device using no two-component curable resin according to Comparative Example 1 showed low close contacting properties and transparency, while the window for a display device using the light transmittance resin having a thermal distortion temperature of 82° C. according to Comparative Example 2 showed low transparency and insufficient appearance. Based on the results, the window for a display device using a two-component curable resin including a light transmittance resin layer having thermal distortion temperature of greater than or equal to 90° C. and isocyanate as a curing agent had satisfactory close contacting properties, transparency, and appearance.

While the invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A window for a display device, comprising
a plastic substrate;
a light transmittance resin layer positioned on one side of the plastic substrate and including a light transmittance resin having a thermal distortion temperature of not less than about 90° C.; and
a binder layer positioned between the plastic substrate and the light transmittance resin layer and including a thermosetting resin and an isocyanate compound.

2. The window for a display device of claim 1, wherein the light transmittance resin comprises one of polycarbonate (PC), polymethylmethacrylate (PMMA), a polycarbonate-polymethylmethacrylate (PC-PMMA) copolymer, a cycloolefin polymer (COP), a copolymer thereof, and a combination thereof.

3. The window for a display device of claim 1, wherein the light transmittance resin has a thermal distortion temperature in a range of about 90° C. to about 150° C.

4. The window for a display device of claim 1, wherein the light transmittance resin has a molecular weight in a range of about 20000 to about 50000.

5. The window for a display device of claim 1, wherein the thermosetting resin comprises one of a urethane-based resin, a polyester-based resin, and a combination thereof.

6. The window for a display device of claim 1, wherein the isocyanate compound is included in an amount in a range of about 1% to about 10% based on the total amount of the binder layer.

7. The window for a display device of claim 1, wherein the plastic substrate comprises one of a polyethyleneterephthalate (PET) film, a polycarbonate (PC) film, a polymethylmethacrylate (PMMA) film, a polycarbonate/polymethylmethacrylate (PC/PMMA) film, and a combination thereof.

8. The window for a display device of claim 1, wherein the window for a display device further comprises an auxiliary layer positioned between the plastic substrate and the light transmittance resin layer and including a thermoplastic resin.

9. The window for a display device of claim 8, wherein the thermoplastic resin comprises one of polycarbonate, an acryl-based resin, a polyester-based resin, and a combination thereof.

10. The window for a display device of claim 8, wherein the window for a display device has a sequential stacking structure in an order of the plastic substrate, the binder layer, the auxiliary layer, and the light transmittance resin layer.

11. The window for a display device of claim 1, wherein the window for a display device further comprises a hard coating layer positioned another side of at least one of the light transmittance resin layer and the binder layer relative to the plastic substrate.

12. The window for a display device of claim 11, wherein the hard coating layer comprises one of an organic material, an inorganic material, and an organic/inorganic composite compound.

13. The window for a display device of claim 1, wherein the window for a display device has a thickness not greater than about 1 mm.

14. The window for a display device of claim 13, wherein the window for a display device has a thickness in a range of about 0.4 mm to about 1.0 mm.

15. The window for a display device of claim 1, wherein the window for a display device is obtained by injection molding the plastic substrate, the light transmittance resin layer, and the binder layer in a film insert manner.

16. A display device comprising the window for a display device of claim 1.
